(19) United States
(12) Patent Application Publication
(10) Pub. No.: US 2013/0337758 A1
(43) Pub. Date: Dec. 19, 2013

(54) WIRELESS RECEIVER AND ELECTRONIC DEVICE WITH SIGNAL GAIN AND REDUCTION

(71) Applicant: HON HAI PRECISION INDUSTRY CO., LTD., New Taipei (TW)

(72) Inventor: KUO-CHIN HSIEH, New Taipei (TW)

(73) Assignee: HON HAI PRECISION INDUSTRY CO., LTD., New Taipei (TW)

(21) Appl. No.: 13/726,616

(22) Filed: Dec. 26, 2012

(30) Foreign Application Priority Data
Jun. 19, 2012 (TW) 101121844

(51) Int. Cl. H04B 1/06

(52) U.S. Cl. CPC H04B 1/06
USPC 455/234.1

(57) ABSTRACT

A wireless receiver includes a low noise amplifier (LNA), a tuner, a demodulator, and an automatic gain controller (AGC). The LNA receives a radio frequency (RF) signal and amplifies the received RF signal. The tuner converts the amplified RF signal to an intermediate frequency (IF) signal. The demodulator demodulates the IF signal. The AGC generates a gain control signal. The LNA applies normal mode to amplify the received RF signal when the gain control signal is larger than a first predetermined voltage; and enters a degradation mode to reduce the strength of the received RF signal when the gain control signal is below a second predetermined voltage lower than the first predetermined voltage.

### BACKGROUND

1. Technical Field

The present disclosure relates to a wireless transmission and reception systems, and particularly to a television wireless receiver and electronic device using the wireless receiver.

2. Description of Related Art

A conventional wireless receiver system includes an antenna, a tuner, an RF low noise amplifier (LNA), a demodulator and an automatic gain controller (AGC). The antenna receives radio frequency (RF) signals. The LNA amplifies the received RF signals. The tuner converts the received RF signals into intermediate frequency (IF) signals. The AGC controls the gain of the tuner. However, if the lowest gain of the demodulator is 0 dB, the received RF signals will be too large, and saturation will lead to distortion of the signals outputted by the tuner, which results in a significant decrease in performance.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

The FIGURE is a block diagram of the functioning modules of the wireless receiver of an electronic device.

### DETAILED DESCRIPTION

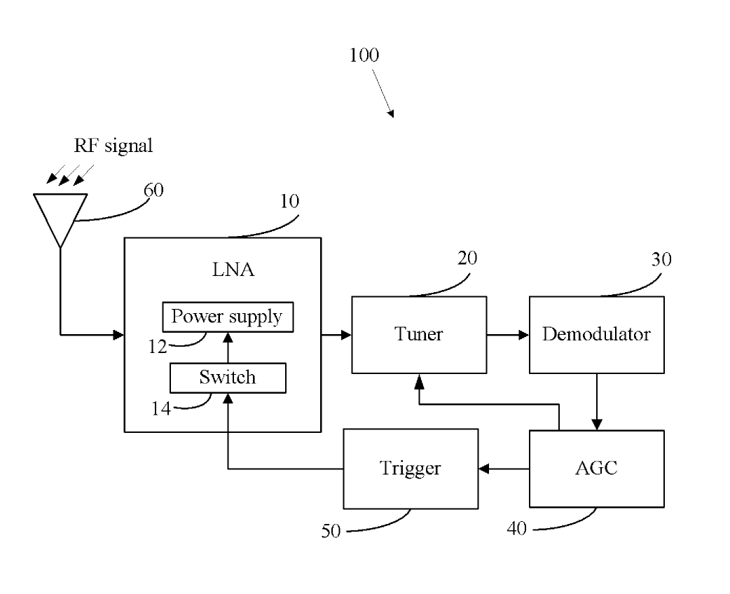

Referring to FIG. 1, a wireless receiver 100 includes an antenna 60, a low noise amplifier (LNA) 10, a tuner 20, a demodulator 30, an automatic gain controller (AGC) 40, and a trigger 50. The wireless receiver 100 is contained in an electronic device such as a television, a set top box, a media player or the like.

The antenna 60 receives RF signals. The LNA 10 amplifies the received RF signals and transmits the amplified RF signals to the tuner 20. The LNA 10 includes a power supply 12 and a switch 14. The switch 14 enables or disables the power supply 12. The LNA 10 enters a normal mode when the power is enabled. The LNA 10 enters a degradation or reduction mode when the power supply 12 is disabled. In this embodiment, in the normal mode of the LNA 10, a gain of the LNA 10 is 15 dB to which level the LNA 10 amplifies the received RF signals. In the degradation mode, the gain of the LNA 10 is negative, at −25 dB, and the LNA 10 reduces or degrades the received RF signals.

The tuner 20 converts the amplified signals to intermediate frequency (IF) signals. The demodulator 30 demodulates the IF signals, and transmits the demodulated signals to the AGC 40. The AGC 40 generates a gain control signal to control the gain of the tuner 20 based on the intensity or strength of the demodulated signals. For example, when the RF signal is strong, the demodulated signal will be strong, and the gain control signal outputted by the AGC 40 will thus be lower. If the RF signal is weak, the demodulated signal will be weak, and the gain control signal outputted by the AGC 40 will thus be large.

The trigger 50 detects whether the gain control signal is greater than a first predetermined voltage or below a second predetermined voltage. The first predetermined voltage is larger than the second predetermined voltage. The trigger 50 generates a first control signal to control the switch 14 to enable the power supply 12 when the voltage of the gain control signal is greater than the first predetermined voltage, such that the LNA 10 applies the normal mode to amplify the received RF signals. The trigger 50 generates a second control signal to control the switch 14 to disable the power supply 12 when the gain control signal is below the first predetermined voltage, such that the LNA 10 applies the degradation mode to reduce the strength of the received RF signals.

As described above, when the received RF signal is larger than a threshold level, the switch 12 disables the power supply 14, and the LNA 10 degrades the received RF signals so as to prevent saturation of the tuner 20.

It is to be understood, however, that even though relevant information and the advantages of the present embodiments have been set forth in the foregoing description, together with details of the functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. A wireless receiver, comprising:
a low noise amplifier (LNA) for receiving a radio frequency (RF) signal and amplifying the received RF signal;
a tuner converting the amplified RF signal to an intermediate frequency (IF) signal;
a demodulator demodulating the IF signal; and
an automatic gain controller (AGC) generating a gain control signal;
wherein the LNA enters a normal mode to amplify the received RF signal when the gain control signal is larger than a first predetermined voltage; and the LNA enters a degradation mode to degrade the received RF signal when the gain control signal is below a second predetermined voltage which is lower than the first predetermined voltage.

2. The wireless receiver of claim 1, wherein the LNA comprises a switch and power supply, the switch disenables the power supply to make the LNA enter the degradation mode when the gain control signal is lower than the second predetermined voltage.

3. The wireless receiver of claim 1, wherein the LNA comprises a switch and power supply, the switch enables the power supply to make the LNA enter the normal mode when the gain control signal is larger than the first predetermined voltage.

4. The wireless receiver of claim 1, wherein the wireless receiver comprises a trigger, the trigger detects whether the gain control signal is larger than the first predetermined voltage or the gain control signal is lower than the second predetermined voltage, the trigger generates a first control signal to control the switch to enable the power supply when the gain control signal is larger than the first predetermined voltage, and the trigger generates a second control signal to disable the power supply when the gain control signal is lower than the second predetermined voltage.

5. An electronic device, comprising:
a tuner receiving an radio frequency (RF) signal;
a low noise amplifier (LNA) amplifying the received RF signal;
a tuner converting the amplified RF signal to an intermediate frequency (IF) signal;
a demodulator demodulating the IF signal; and
an automatic gain controller (AGC) generating a gain control signal;
wherein the LNA enters a normal mode to amplify the received RF signal when the gain control signal is larger than a first predetermined voltage; and the LNA enters a degradation mode to degrade the received RF signal when the gain control signal is below a second predetermined voltage which is lower than the first predetermined voltage.

6. The electronic device of claim 5, wherein the LNA comprises a switch and power supply, the switch disenables the power supply to make the LNA enter the degradation mode when the gain control signal is lower than the second predetermined voltage.

7. The electronic device of claim 5, wherein the LNA comprises a switch and power supply, the switch enables the power supply to make the LNA enter the normal mode when the gain control signal is larger than the first predetermined voltage.

8. The electronic device of claim 5, wherein the electronic device further comprises a trigger, the trigger detects whether the gain control signal is larger than the first predetermined voltage or the gain control signal is lower than the second predetermined voltage, the trigger generates a first control signal to control the switch to enable the power supply when the gain control signal is larger than the first predetermined voltage, and the trigger generates a second control signal to disable the power supply when the gain control signal is lower than the second predetermined voltage.
